(19) United States
(12) Patent Application Publication
(10) Pub. No.: US 2022/0032512 A1
(43) Pub. Date: Feb. 3, 2022

(54) VEHICLE COMPONENT FOR A MOTOR VEHICLE AND METHOD FOR PRODUCING A VEHICLE COMPONENT OF THIS KIND

(71) Applicant: ZF Friedrichshafen AG, Friedrichshafen (DE)

(72) Inventors: Jan DUETZ, Wangerland (DE); Konstantin BRUNNER, Damme (DE); Ernst Willi Sven KUHLMANN, Lemförde (DE)

(21) Appl. No.: 17/280,356

(22) PCT Filed: Sep. 17, 2019
(86) PCT No.: PCT/EP2019/074800

§ 371 Date: Mar. 26, 2021

(30) Foreign Application Priority Data
Oct. 19, 2018 (DE) 10 2018 217 910.7

(51) Int. Cl. B29C 45/14; B60G 7/00

(52) U.S. Cl. CPC B29C 45/14065; B60G 7/001; B60G 2206/11; B29L 2031/30; B60G 2206/81012; B29C 2045/14122; B60G 2206/7101

(57) ABSTRACT

A vehicle component (1, 17, 31, 46, 55, 62) for a motor vehicle, with a structural component (7, 16, 30) and with a casing (2, 18, 32, 38, 56, 57, 79). The structural component (7, 16, 30) is at least partially or completely overmolded and/or embedded by casting in order to form the casing (2, 18, 32, 38, 56, 57, 79). To avoid any interruption of the casing (2, 18, 32, 38, 56, 57, 79) and/or interruption of corrosion protection in the area of the holding point (8), a holding point covering (12, 15, 39, 36, 45, 54, 61) is arranged at a holding point (8) for holding the structural component (7, 16, 30) in an injection-molding die and/or a casting mold.

This application is a National Stage completion of PCT/EP2019/074800 filed Sep. 17, 2019, which claims priority from German patent application serial no. 10 2018 217 910.7 filed Oct. 19, 2018.

### FIELD OF THE INVENTION

The invention relates to a vehicle component for a motor vehicle, with a structural component and with a casing, wherein to form the casing the structural component is at least partially or completely overmolded or embedded by casting in a material. In addition the invention relates to a method for producing a vehicle component of this kind for a motor vehicle, wherein to form the casing the structural component is at least partially or completely overmolded with or embedded by casting in a material.

### BACKGROUND OF THE INVENTION

A vehicle component and method of that type is known from DE 10 2007 015 615 A1.

To overmold the structural component, it has to be positioned and held in an injection-molding die and/or a casting mold. For the positioning or holding of the structural component, as a rule the injection-molding die and/or casting mold comprises a plurality of positioning elements. These positioning elements can be in the form of positioning pins whose free ends are pressed against predetermined holding points on an area or surface of the structural component, whereby the structural component can be held within a cavity of the injection-molding die and/or casting mold and kept a distance away from its walls. Then, the overmolding and/or embedding of the structural component by casting-in to make the casing can take place.

This has the disadvantage that after the overmolding and/or casting-in, the positioning elements are withdrawn again from the structural component, whereby the holding point or points of the structural component on an associated area or surface of the structural component is or are left free. Thus, for example the corrosion protection provided by the casing can be interrupted in the area of the holding points. This harbors the risk of undesired local corrosion. Subsequent sealing of the casing in the area of the holding points, or some other kind of pretreatment or after-treatment to provide corrosion protection in the area of the holding points, is as a rule complicated and/or incurs undesired costs.

### SUMMARY OF THE INVENTION

The purpose of the present invention is to develop further a vehicle component and/or a method of the type mentioned at the beginning, in such manner that leaving in place an interruption of the casing and/or an interruption of corrosion protection in the area of the holding points is avoided. Preferably, leaving a freely accessible area and/or surface of the structural component in the area of the holding points can be avoided. In particular an alternative embodiment should be provided.

The set objective of the invention is achieved by a vehicle component according to the independent claim(s) and by a method according to the independent claim(s). Preferred further developments of the invention emerge from the subordinate claims and from the description.

The vehicle component is intended for use in a motor vehicle, for example a passenger car or a utility vehicle. In this context the vehicle component comprises a structural component. In particular, the structural component determines a basic shape and/or contour of the vehicle component. The structural component can be of stable shape, solid or substantially solid. In addition the vehicle component has a casing. In this context the structural component is at least partially or, in a preferred embodiment, essentially completely encased and/or enclosed by the casing. In particular, the structural component is at least partially or completely embedded in the casing. To form the casing, the structural component is overmolded and/or embedded by casting in a suitable material. The structural component has at least one holding point, in particular a plurality of holding points for holding the structural component in an injection-molding die and/or casting mold. According to the invention, at the holding points a holding point covering is arranged.

In this case it is advantageous that the arrangement of a suitably designed holding point covering at the holding points enables the holding points to be covered and/or sealed. In that way, leaving in place an interruption of the casing and/or of a corrosion protection means in the area of the holding points can be avoided. In particular, by virtue of the holding point covering, an area and/or surface of the structural component in the area of the holding points is or can be covered, preferably lastingly. In particular the holding point covering is in the form of a separate and/or stand-alone device or as a corresponding component. Preferably, the holding point covering is or will be prefabricated. In that way the prefabricated holding point covering can be used for the subsequent production of the vehicle component.

Preferably, the holding point covering is in contact with the structural component and is partially overmolded and/or embedded by casting in the material of the casing. Thus, the holding point covering rests directly against the area and/or surface of the structural component. Preferably, the area and/or surface of the structural component in contact with the holding point covering defines the holding points of the structural component for holding the same in the injection-molding die and/or casting mold. In particular, by virtue of the overmolding and/or casting, the holding point covering is connected firmly to the casing and/or the structural component. Preferably, the holding point covering is held onto the structural component and/or the casing with interlock, by material-merging, or by frictional force.

According to a further embodiment, the holding point covering and the casing are made from the same material. The material can be corrosion-protective or corrosion-inhibiting. In particular, the holding point covering is made of plastic or a fiber-reinforced plastic.

Thus, the casing and the holding point covering can protect the structural component against corrosion. Particularly when the structural component is completely embedded in the casing and the holding points are in each case covered by a holding point covering, the structural component can be fully screened against environmental influences. Moreover, the casing can provide additional strengthening of the vehicle component and/or can increase its rigidity.

According to a further development, the holding point covering provides a contact area for a positioning element of the injection-molding die and/or the casting mold. By means of the positioning element, in particular a plurality of positioning elements, the structural component can be positioned and held in a cavity or hollow space of the injection-molding die and/or the casting mold. In this, the structural component can be held in the cavity of the injection and/or casting mold by means of the positioning element or elements in such manner that the structural component is kept a distance away from the walls of the cavity so that the material for making the casing can be injected and/or cast between the walls and the structural component itself. In particular a positioning element is in the form of a positioning pin. Thus, a free end of the positioning pin can co-operate with the holding point covering or the contacting area of the holding point covering. Accordingly, by virtue of the holding point covering immediate or direct contact between the positioning element and the area and/or surface of the structural component can be avoided. Instead, the holding point covering is arranged between the positioning element and the structural component. In that way the contacting area of the holding point covering is in contact with the positioning element and a side of the holding point covering that faces away from the contacting area is in contact with the structural component. In particular, in its contacting area the holding point covering has a larger diameter than the free end of the positioning element. This ensures that the material of the casing can enclose the holding point covering in such manner that after the removal of the positioning element, the holding point covering is held onto the structural component or its holding point by means of the casing.

According to a further development, the holding point covering has a receiving section for holding part of the positioning element. The holding point covering can be arranged on the positioning element by means of the receiving section. In particular the receiving section is in the form of a blind hole. Thereby, the holding point covering can be fitted onto a free end of the positioning element. In particular, an inner contour of the receiving section is designed to correspond to an outer contour, preferably a free end, of the positioning element. The positioning element or positioning pin can be moved or adjusted in the direction of a longitudinal axis of the positioning element or positioning pin. In a retracted condition of the positioning element, the structural component can be placed into the injection and/or casting mold or removed from the injection and/or casting mold. In an inserted condition of the positioning element, the structural component and/or the vehicle component is held inside the injection-molding die and/or the casting mold. After the casing has been made and due to the partial overmolding and/or casting-in of the holding point covering with the casing material, the holding point covering remains on the structural component when, after the casing has been made, the positioning element is retracted to allow the extraction of the vehicle component from the injection and/or casting mold.

Preferably, at least on one side the holding point covering is in contact with the area and/or surface of the structural component. In particular, the holding point covering is in contact with a side or area of the structural component that faces toward the positioning element. Depending on the specific design of the holding point covering and/or the holding point of the structural component, the holding point covering can be in contact all over the area and/or surface of the structural component, or only part of it.

According to a further development, the holding point covering is made integrally, in one piece. An integral design of the holding point covering enables it to be produced particularly inexpensively and/or handled easily. Alternatively the holding point covering can be made with several parts, or two parts. Preferably, a two-part holding point covering is produced with two identical parts. In the case of a multi-part or two-part design of the holding point covering, the parts of the holding point covering can be connected to one another by a snap-in or a detent connection. In the case of a two-part holding point covering, this can comprise a first covering element and a second covering element. To form the holding point covering, the first covering element and the second covering element can be connected to one another by means of the snap-in or detent connection.

In a further development, the structural component has an opening. In particular, the opening is arranged in the area of the holding point of the structural component. This enables the holding point covering to extend through the opening of the structural component. The opening can be in the form of a circular hole or an elongated hole. Preferably, the holding point covering co-operates with two sides or areas of the structural component that face away from one another in the area of the opening. Due to the fact that the holding point covering extends through the opening of the structural component, the holding point covering can for example co-operate both with an outside of the structural component and also with an inside of the structural component arranged to face away from the outside.

Preferably, the holding point covering comprises at least one snap-in and/or detent section for producing an interlocking connection of the holding point covering to the structural component. By means of the snap-in and/or detent section, the holding point covering can be arranged, held and/or fixed in the opening of the structural component. In particular, by virtue of the interlocking connection of the snap-in and/or detent section, the holding point covering is secured on the structural component against becoming detached. In that way the holding point covering can be secured at the holding point or in the opening of the structural component already before the structural component is arranged in the injection-molding die and/or casting mold. This improves the handling and/or the process reliability. The snap-in and/or detent section of the holding point covering can have one, two or more retaining hooks. In particular, the snap-in and/or detent section has two retaining hooks arranged mirror-symmetrically relative to one another. Preferably, the snap-in and/or detent section or its retaining hooks are designed to bend elastically.

According to a further embodiment, the structural component is made of a metal or a sheet material. Thus, the vehicle component can be produced as a plastic-metal hybrid component. In this, the casing together with the at least one holding point covering can provide corrosion protection for the metallic structural component. The vehicle component can be in the form of a pedal, a chassis component, in particular a control arm, or a track-rod.

In the method for producing a vehicle component, specifically a vehicle component according to the invention, to form the casing the structural component is at least partially, or completely or substantially completely overmolded with and/or embedded by casting in a material. In doing this, according to the invention the holding point covering is arranged at the holding points in the injection-molding die and/or the casting mold.

In particular, to hold the structural component in the injection-molding die and/or casting mold, the holding point covering is arranged between the structural component and the positioning element of the injection-molding die and/or casting mold. This prevents the positioning element from resting directly against the area and/or surface of the structural component and thereby leaving an uncovered holding point after the positioning element has been removed.

Instead, the holding point covering can be partially overmolded and/or embedded by casting in the material of the casing, whereby the holding point covering is connected firmly to the casing and/or the structural component. Thus, after the positioning element has been removed the holding point covering can remain on the structural component or vehicle component. By means of the holding point covering, the holding point on the structural component can be covered. Thus, an interruption of the corrosion protection of the structural component can be avoided.

### BRIEF DESCRIPTION OF THE DRAWINGS

Below, the invention is described in greater detail with reference to the figures, in which the same indexes denote the same, similar or functionally equivalent components. The figures show:

FIG. 1: A perspective view of a vehicle component according to the invention,

FIG. 2: A perspective view of a structural component for a vehicle component according to the invention, as in FIG. 1,

FIG. 3: A perspective view of the structural component according to FIG. 2, with first holding point coverings at holding points of the structural component,

FIG. 4: A partial sectional side view of a second holding point covering on a structural component, for forming a vehicle component according to the invention,

FIG. 5: A partial sectional side view of a third holding point covering on a structural component, for forming a vehicle component according to the invention,

FIG. 6: A partial sectional side view of a fourth holding point covering on a structural component, for forming a vehicle component according to the invention,

FIG. 7: A partial dually-sectioned side view of a fifth holding point covering on a structural component, for forming a vehicle component according to the invention,

FIG. 8: A partial dually-sectioned side view of a sixth holding point covering on a structural component, for forming a vehicle component according to the invention,

FIG. 9: A partial sectional side view of a further holding point covering on a structural component, for forming a vehicle component according to the invention.

### DETAILED DESCRIPTION OF THE PREFERRED EMBODIMENTS

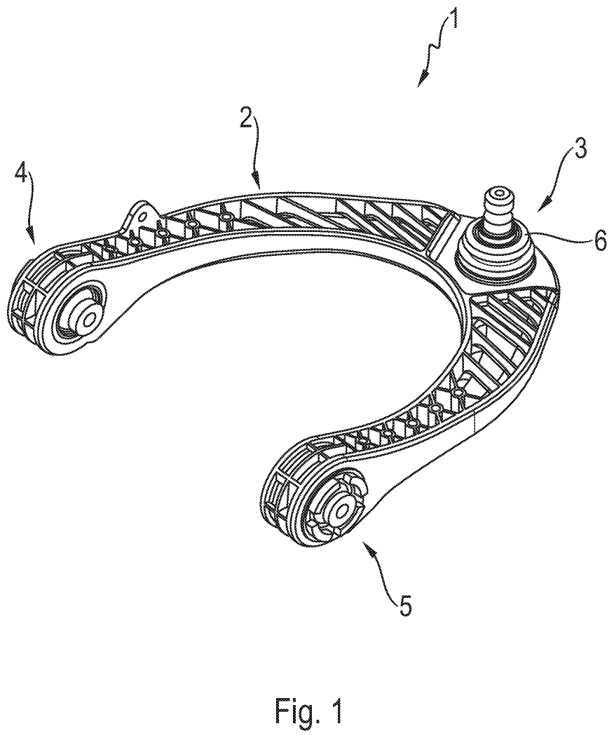

FIG. 1 shows a perspective view of a vehicle component 1 according to the invention. In this example embodiment the vehicle component 1 is in the form of a chassis component, namely a control arm or three-point control arm. The vehicle component 1 has a casing 2. In this instance the casing 2 is made of plastic. A structural component (not visible here) is embedded in the casing 2. In this example embodiment the structural component is essentially completely encased in the casing 2. The casing 2 serves as corrosion protection for the structural component and at the same time increases its rigidity and/or reinforces it.

In this example embodiment, the vehicle component 1 has three joints 3, 4 and 5. The joint 3 here is in the form of a ball stud joint which has a sealing bellows 6. The joints 4 and 5 are here, for example, in the form of ball sleeve joints or alternatively rubber mountings.

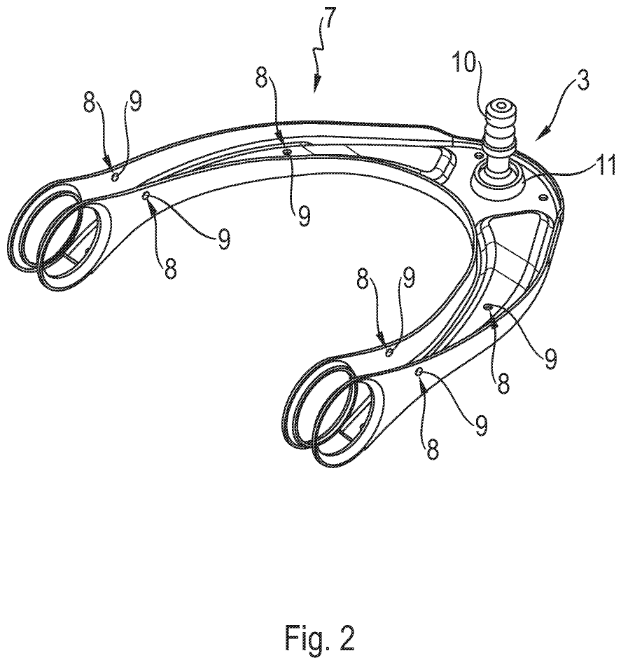

FIG. 2 shows a perspective side view of a structural component 7 for the vehicle component 1 according to the invention shown in FIG. 1. In this example embodiment the structural component 7 is made of metal, namely sheet metal. The structural component 7 determines the basic shape or contour of the vehicle component 1 in FIG. 1.

The structural component 7 has a plurality of holding points 8. The holding points 8 serve for the positioning and holding of the structural component 7 within an injection-molding die and/or a casting mold (not shown here).

In this example embodiment, the holding points 8 have in each case an opening 9, for example in the form of a circular hole. Alternatively, individual or all the openings 9 can be made as elongated holes.

In this example embodiment, the joint 3 with a joint stud 10 and a joint housing 11 is already connected to or pressed into the structural component 7.

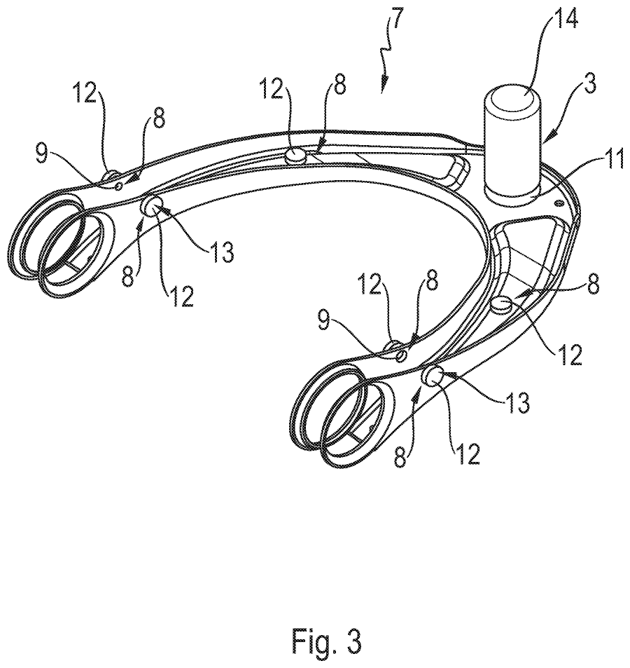

FIG. 3 shows a perspective view of the structural component 7 according to FIG. 2, with a first holding point covering 12 at the holding points 8 of the structural component 7. In this example embodiment, the holding point coverings 12 are designed essentially like a mushroom-cap or have a T-shaped cross-section. Here, the holding point coverings 12 are partially inserted into the openings 9 of the holding points 8. In this example embodiment, the holding point coverings 12 are made from the same material as the casing 2 shown in FIG. 1.

Furthermore, the holding point coverings 12 have in each case a contacting area 13 for a positioning element (not shown) of an injection and/or casting mold. In this example embodiment the contacting areas are essentially in the form of flat, circular-disk-like surfaces. For greater simplicity, not all the contacting areas 13 have been indexed.

Furthermore, in this example embodiment a sealing sleeve 14 is fitted over the joint stud 10 in FIG. 2. The sealing sleeve 14 is in contact with the joint housing 11. The sealing sleeve 14 prevents the material of the casing 2 from penetrating into the joint 3 when the structural component 7 is overmolded and/or cast-in for producing the casing 2 shown in FIG. 1. The sealing sleeve 14, as also the positioning element or elements, can be constituents of the injection-molding die and/or the casting mold (not shown here).

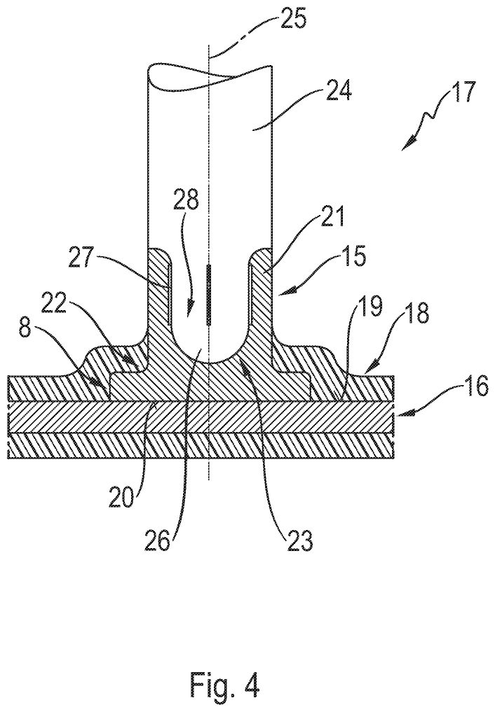

FIG. 4 shows part of a sectioned side view of a second holding point covering 15 on a structural component 16 for producing a vehicle component 17 according to the invention. Here too, the structural component 16 is made of metal or sheeting. In addition the vehicle component 17 has a casing 18. In this example embodiment the casing 18 is made of a plastic.

At a holding point 8 of the structural component 16 the holding point covering 15 rests, flat, in contact with a side, area or surface 19. In contrast to the structural component 7 according to FIGS. 2 and 3, the holding point 8 of the structural component 16 has no opening 9.

The holding point covering 15 is designed essentially like a mushroom-cap. In this case a face 20 of the holding point covering 15 rests against or on the surface 19. On a side facing away from the face 20 and the structural component 16, the holding point covering 15 has a receiving section 21. The receiving section 21 has a recess so that the receiving section 21 is in the form of a blind hole. An outer diameter of the receiving section 21 is smaller than an area of the holding point covering 15 with the face 20. This forms a step-like offset 22 or recess. The holding point covering 15 is partially enclosed by the casing 18. In this example embodiment the casing 18 overlaps the offset 22. In that way the holding point covering 15 is connected firmly and permanently by means of the casing 18 to the holding point 8 and the structural component 16 or vehicle component 17.

The receiving section 21 serves to provide a contact area 23 for a positioning element 24. The positioning element 24 is part of an injection-molding die and/or casting mold (not shown here). In this case the positioning element 24 can be moved in the direction of a longitudinal axis 25 of the positioning element 24, and can be held in at least two different positions. Here, the positioning element 24 is shown in an inserted position in which the positioning element co-operates with the holding point covering 15 and the holding point covering 15 is in contact with the surface 19 of the structural component 16. In a retracted position of the positioning element 24 (not shown here), the positioning element 24 moves back out of the receiving section 21 so that the vehicle component 17 can be extracted from the injection-molding die and/or casting mold.

In this example embodiment the positioning element 24 is in the form of a positioning pin. In this case the positioning element 24 has a free end 26 whose outer contour is designed to correspond to the inner contour of the receiving section 21. In this example embodiment, at its free end 26 the positioning element 24 has ribs 27 that extend axially relative to the longitudinal axis 25. The ribs 27 are, for example, in the form of crush ribs. A plurality of ribs 27 are uniformly distributed around an outer periphery of the free end 26. In this illustration, for the sake of a clearer representation the ribs 27 are indicated only schematically. In fact, when the positioning element 24 or its free end 26 is inserted into the hollow-cylindrical receiving section 21, the material of the ribs 27 is compressed or crushed. Thereby, undesired detachment of the holding point covering 15 from the positioning element 24 can be avoided. This is particularly advantageous when the holding point covering 15 is fitted onto the positioning element 24 first, and only then are the positioning element 24 with the holding point covering 15 on it moved to the holding point 8.

By virtue of the receiving section 21, the holding point covering 15 can first be fitted onto the free end 26. By virtue of the ribs 27, the holding point covering 15 is held sufficiently securely on the positioning element 24. Thereafter, the structural component 16 can be placed into the injection-molding die and/or casting mold and, in particular by means of a plurality of positioning elements 24, it can be positioned and held in a cavity of the injection and/or casting mold. Thereby, at the same time the holding point coverings 15 can be positioned on the holding points 8 of the structural component 16. Then the casing 18 is produced, whereby the holding point covering 15 is connected to the structural component 16 and held on it. After the casing 18 has been produced, the positioning element 24 moves back to a retracted position but the holding point covering 15 remains on the vehicle component 17.

To facilitate the retraction of the positioning element 24 or its free end 26 from the receiving section 21, in this example embodiment the free end 26 has a number of mold release oblique surfaces 28. In this example embodiment an oblique surface 28 is arranged in each case between two adjacent ribs 27 on the outer circumference of the free end 26.

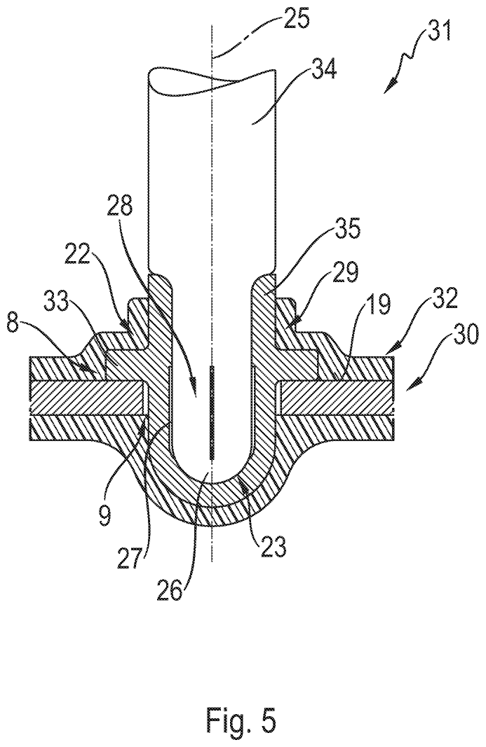

FIG. 5 shows part of a sectioned side view of a third holding point covering 29 on a structural component 30 for producing a vehicle component 31 according to the invention. The structural component 30 is made from a sheet material and encased in a casing 32 made of plastic. At a holding point 8 of the structural component 30, an opening 9 is provided. The holding point covering 29 extends through the opening 9. The holding point covering 29 has an annular web 33. The annular web 33 rests on one side against a surface 19 of the structural component 30. Thereby, an insertion movement of a positioning element 34 for inserting the holding point covering 29 into the opening 9 is limited. The positioning element 34 is designed similarly to the positioning element 24 in FIG. 4.

The positioning element 34 corresponds to a receiving section 35, which in this example embodiment is in the form of a blind hole. The free end 26 of the positioning element 34 is designed to correspond to the receiving section 35. In that respect reference should be made to the description relating to FIG. 4.

Similarly to the design according to FIG. 4, the web 33 forms an offset 22 or recess, which is in the form of a step. The web 33 and the step 22, as well as the part of the holding point covering 29 that extends through the opening 9, is overmolded or embedded by casting in the material of the casing 32. In that way the holding point covering 29 is fixed permanently onto the holding point 8 and in the opening 9.

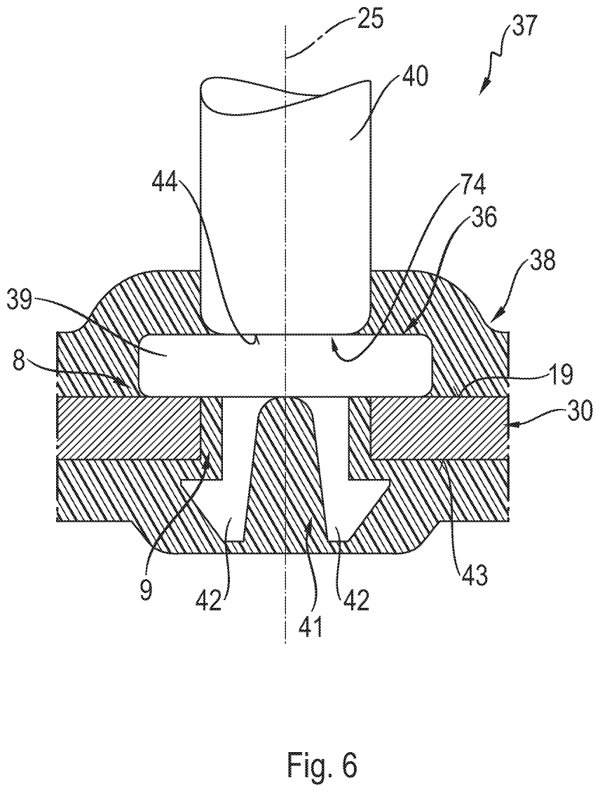

FIG. 6 shows part of a sectioned side view of a fourth holding point covering 36 on a structural component 30 for forming a vehicle component 37 according to the invention. The metallic structural component 30 is embedded in a casing 38 made of plastic. The holding point covering 36 is designed essentially like a mushroom-cap. In this case a plate section 39 of the holding point covering 36 rests in contact with the surface 19 of the structural component 30. Thus, an insertion travel for inserting the holding point covering 36 into the opening 9 of the structural component 30 is limited by the plate section 39.

The holding point covering 36 has a snap-in and/or detent section 41 which, starting from the plate section 39, extends through the opening 9. In this example embodiment, the snap-in and/or detent section 41 has two retaining hooks 42. The two retaining hooks 42 are formed mirror-symmetrically relative to one another and/or to the longitudinal axis 25. The retaining hooks 42 are elastic and are designed to bend inward relative to the longitudinal axis 25. In an area facing away from the plate section 39 or the surface 19, the retaining hooks 41 project out through the opening 9. The retaining hooks 42 co-operate, in particular directly or indirectly, with a side 43 of the structural component 30 that faces away from the plate section 39, the surface 19 or a positioning element 40. The retaining hooks 42 are completely embedded in the material of the casing 38. Moreover, an outer edge of the plate section 39 is also embedded in the material of the casing 38.

An end face 44 of the positioning element 40 rests in contact with a contacting area 74 facing away from the snap-in and/or detent section 41, which in this case is already formed by a face of the plate section 39.

By means of the snap-in and/or detent section 41, the holding point covering 36 can be pre-fitted in the opening 9 of the structural component 30. Thereby, the snap-in and/or detent section 41 at the same time ensures a secure attachment for the holding point covering 36 on the structural component 30.

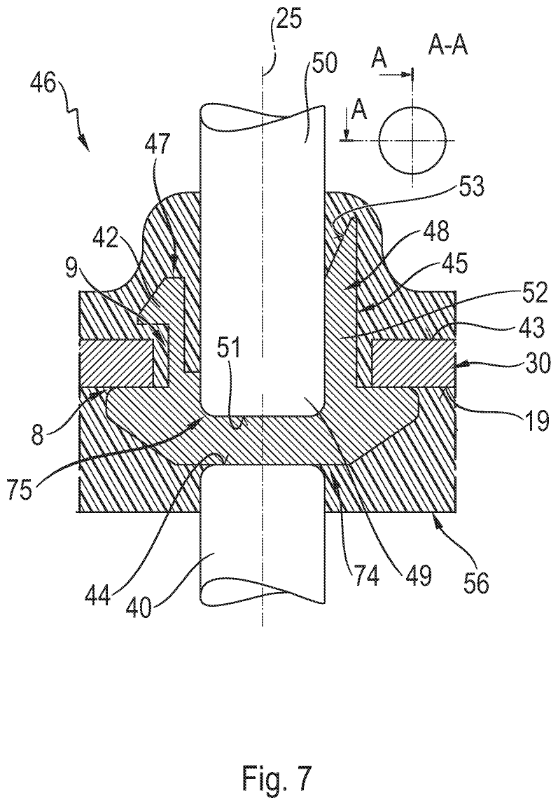

FIG. 7 shows part of a dually-sectioned side view of a fifth holding point covering 45 on a structural component 30 for producing a vehicle component 46 according to the invention. The holding point covering 45 is similar to the holding point covering 36 in FIG. 6. In that respect, reference should be made to the previous description.

According to FIG. 7, having regard to the part-figure A-A, to the left of the longitudinal axis 25 there is a first partial cross-section of the holding point covering 45, and to the right of the longitudinal axis 25 there is a second partial cross-section arranged at a right-angle to the first partial cross-section. The respective other sides of the left and right partial cross-sections (not shown here) are formed mirror-symmetrically to the first partial cross-section on the left and the second partial cross-section on the right.

Thus, the holding point covering 45 has a snap-in and/or detent section 47 formed similarly to the snap-in and/or detent section 41 in FIG. 6. Correspondingly, the snap-in and/or detent section 47 has two retaining hooks 42 arranged mirror-symmetrically relative to one another. However, otherwise than with the snap-in and/or detent section 41 in FIG. 6, the snap-in and/or detent section 47 according to FIG. 7 has a receiving section 48 for receiving a free end 49 of a further positioning element 50. The receiving section 48 is essentially in the form of a blind hole and the free end 49 of the further positioning element 50, at least in the area of an end face 51 of the further positioning element 50, is designed to fit into the receiving section 48 and to be held therein. Thus, the free end 49 rests against a further contacting area 75 of the holding point covering 45. In this case the contacting areas 74 and 75 are arranged on two sides of the holding point covering that face away from one another.

The retaining hooks 42 are radially a distance away from the further positioning element 50, relative to the longitudinal axis 25. In that way, even if a further positioning element 50 has already been inserted into the receiving section 48 and the holding point covering 45 has been pushed into the opening 9, the retaining hooks 42 can be bent elastically inward in the direction of the further positioning element 50.

Furthermore, according to the partial cross-section on the right the receiving section 48 has a web 52 which is in contact with the outer circumference of the further positioning element 50. The web 52 has at its free end an oblique face 53, which facilitates the insertion of the free end 49 into the receiving section 48. For that purpose the oblique face 53 is directed at an angle, radially inward relative to the longitudinal axis 25.

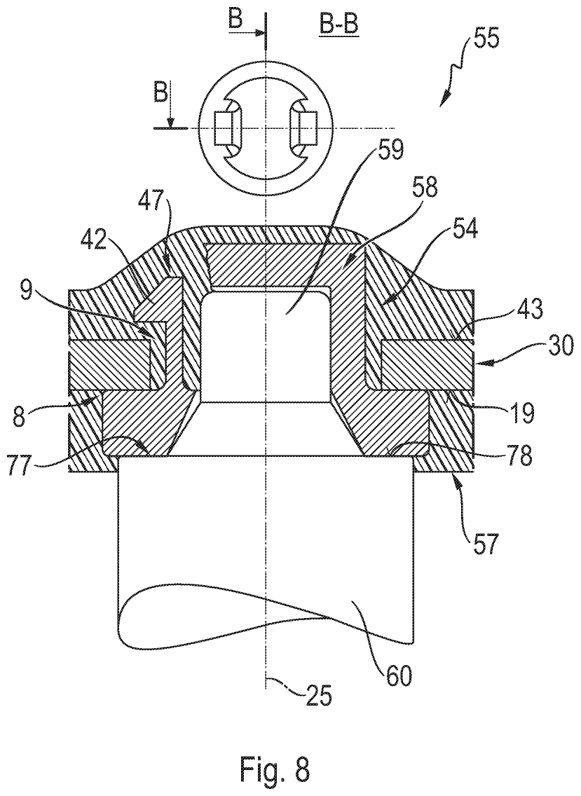

FIG. 8 shows part of a dually-sectioned side view of a sixth holding point covering 54 on a structural component 30 for forming a vehicle component 55 according to the invention. The vehicle component 55 has a casing 57 made of plastic, in which the metallic structural component 30 is embedded.

Having regard to the part-figure B-B, FIG. 8 shows to the left of the longitudinal axis 25 a first partial cross-section and to the right of the longitudinal axis 25 a second partial cross-section arranged at a right-angle to the first partial cross-section. Here, the respectively missing representations of the right and left cross-sections of the first partial cross-section and the second partial cross-section are mirror-symmetrical relative to the first partial cross-section and the second partial cross-section.

Thus, the holding point covering 57 comprises a snap-in and/or detent section 47 with two retaining hooks 42 in the manner of FIG. 7. In that respect reference should be made to the previous description. In the partial cross-section on the right the holding point covering 54 has a receiving section 58 with an essentially U-shaped cross-section for receiving a free end 59 of a positioning element 60. The receiving section 58 is designed to correspond to the free end 59. In this example embodiment the free end 59 serves essentially for the radial positioning of the holding point covering 57. In the axial direction relative to the longitudinal axis 25, the holding point covering has on a side facing away from the receiving section 58 a contacting area 77, with which an annular surface 78 of the positioning element is in contact.

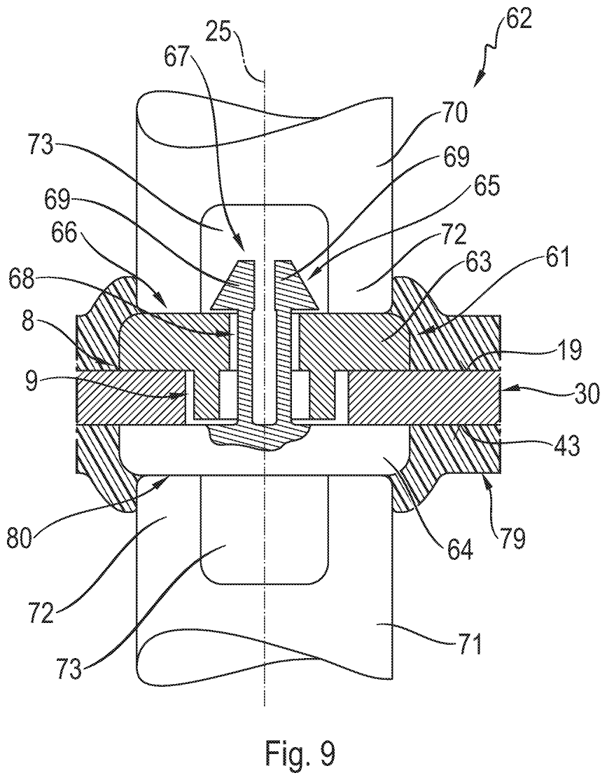

FIG. 9 shows part of a sectioned side view of a further holding point covering 61 on a structural component 30 for forming a vehicle component 62 according to the invention. The vehicle component 62 has a casing 79 made of plastic, in which the metallic structural component 30 is embedded.

The holding point covering 61 is formed of a first covering element 63 and a second covering element 64. The first covering element 63 and the second covering element 64 are connected to one another by means of a snap-in and/or detent connection 65. In this example embodiment, the first covering element 63 is essentially of annular form. Moreover, the second covering element 64 is designed essentially like a mushroom-cap, wherein a snap-in and/or detent section 67 of the second covering element 64 extends through the opening 9 and through an aperture 68 of the first covering element 63. The snap-in and/or detent section 67 has two retaining hooks 69 arranged mirror-symmetrically to one another.

To hold and position the structural component 30 in an injection-molding die and/or casting mold (not shown here), the mold comprises two positioning elements 70, 71. The two positioning elements 70, 71 are arranged or formed mirror-symmetrically to one another. In this case the positioning element rests against a first contacting area 66 of the first covering element 63 and the positioning element 71 rests against a second contacting area 80 of the second covering element 64. In the area of their respective free ends 72 the positioning elements 70, 71 have a recess 73. The recesses 73 provide sufficient free space for the retaining hooks 69.

### INDEXES

1 Vehicle component
2 Casing
3 Joint
4 Joint
5 Joint
6 Sealing bellows
7 Structural component
8 Holding point
9 Opening
10 Joint stud
11 Joint housing
12 Holding point covering
13 Contacting area
14 Sealing sleeve
15 Holding point covering
16 Structural component
17 Vehicle component
18 Casing
19 Area
20 End face
21 Receiving section
22 Offset
23 Contacting area
24 Positioning element
25 Longitudinal axis
26 Free end
27 Rib
28 Mold release oblique surface
29 Holding point covering
30 Structural component
31 Vehicle component
32 Casing
33 Web
34 Positioning element
35 Receiving section
36 Holding point covering
37 Vehicle component
38 Casing
39 Plate section
40 Positioning element
41 Snap-in and/or detent section
42 Retaining hook
43 Side
44 End face
45 Holding point covering
46 Vehicle component
47 Snap-in and/or detent section
48 Receiving section
49 Free end
50 Further positioning element
51 End face
52 Web
53 Oblique face
54 Holding point covering
55 Vehicle component
56 Casing
57 Casing
58 Receiving section
59 Free end
60 Positioning element
61 Holding point covering
62 Vehicle component
63 First covering element
64 Second covering element
65 Snap-in and/or detent connection
66 Contacting area
67 Snap-in and/or detent section
68 Aperture
69 Retaining hook
70 Positioning element
71 Positioning element
72 Free end
73 Recess
74 Contacting area
75 Contacting area
76 Contacting area
77 Contacting area
78 Annular surface
79 Casing
80 Contacting area

1-14. (canceled)

15. A vehicle component for a motor vehicle, the vehicle component comprising:
a structural component (7, 16, 30), and
a casing (2, 18, 32, 38, 56, 57, 79),
wherein the structural component (7, 16, 30) is at least partially or completely overmolded and/or embedded by casting in a material to form the casing (2, 18, 32, 38, 56, 57, 79), and
a holding point covering (12, 15, 39, 36, 45, 54, 61) is arranged at a holding point (8) for holding the structural component (7, 16, 30) in an injection-molding die and/or a casting mold.

16. The vehicle component according to claim 15, wherein the holding point covering (12, 15, 39, 36, 45, 54, 61) is in contact with the structural component (7, 16, 30) and is partially overmolded and/or embedded by casting in the material of the casing (2, 18, 32, 38, 56, 57, 79), and the holding point covering (12, 15, 39, 36, 45, 54, 61) is firmly connected to the casing (2, 18, 32, 38, 56, 57, 79) and/or to the structural component (7, 16, 30).

17. The vehicle component according to claim 15, wherein the holding point covering (12, 15, 39, 36, 45, 54, 61) and the casing (2, 18, 32, 38, 56, 57, 79) are made from the same material.

18. The vehicle component according to claim 15, wherein the holding point covering (12, 15, 39, 36, 45, 54, 61) and/or the casing (2, 18, 32, 38, 56, 57, 79) are made of plastic or a fiber-reinforced plastic.

19. The vehicle component according to claim 15, wherein the casing (2, 18, 32, 38, 56, 57, 79) and the holding point covering (12, 15, 39, 36, 45, 54, 61) provide corrosion protection for the structural component (7, 16, 30).

20. The vehicle component according to claim 15, wherein the holding point covering (12, 15, 39, 36, 45, 54, 61) comprises a contacting area (13, 23, 66, 75, 76, 77) fora positioning element (24, 34, 40, 50, 60, 70, 71) of the injection-molding die and/or the casting mold, and the positioning element (24, 34, 40, 50, 60, 70, 71) is in a form of a positioning pin.

21. The vehicle component according to claim 20, wherein the holding point covering (12, 15, 39, 36, 45, 54, 61) has a receiving section (21, 35, 48, 58) for partially receiving the positioning element (24, 34, 40, 50, 60, 70, 71), and the receiving section (21, 35, 48, 58) is in a form of a blind hole.

22. The vehicle component according to claim 15, wherein on at least one side, the holding point covering (12, 15, 39, 36, 45, 54, 61) is in contact with an area (19, 43) of the structural component (7, 16, 30).

23. The vehicle component according to claim 15, wherein the holding point covering (12, 15, 39, 36, 45, 54, 61) is made of one or two parts.

24. The vehicle component according to claim 23, wherein the two-part holding point covering (12, 15, 39, 36, 45, 54, 61) is formed of two identical components.

25. The vehicle component according to claim 15, wherein the holding point covering (12, 15, 39, 36, 45, 54, 61) extends through an opening (9), a circular hole or an elongated hole in the structural component (7, 16, 30), and the holding point covering (12, 15, 39, 36, 45, 54, 61) cooperates with two sides or areas (19, 43) of the structural component (7, 16, 30) that face away from one another in an area of the opening (9), the circular hole or the elongated hole.

26. The vehicle component according to claim 25, wherein the holding point covering (12, 15, 39, 36, 45, 54, 61) comprises at least one snap-in and/or detent section (41, 47, 67) for producing an interlocking connection of the holding point covering (12, 15, 39, 36, 45, 54, 61) to the structural component (7, 16, 30), and the snap-in and/or detent section (41, 47, 67) has two retaining hooks (42, 69) arranged mirror-symmetrically relative to one another.

27. The vehicle component according to claim 15, wherein the structural component (7, 16, 30) is made of a metal or sheet material, and the vehicle component (1, 17, 31, 37, 46, 55, 62) is a plastic-metal hybrid component.

28. The vehicle component according to claim 27, wherein the plastic-metal hybrid component is one of a pedal, a chassis component, a control arm or a track-rod.

29. A method for producing a vehicle component (1, 17, 31, 37, 46, 55, 62) for a motor vehicle, with a structural component (7, 16, 30) and with a casing (2, 18, 32, 38, 56, 57, 79), the method comprising:
forming the casing (2, 18, 32, 38, 56, 57, 79) by the structural component (7, 16, 30) being at least partially or completely overmolded and/or embedded by casting in a material, and
arranging a holding point covering (12, 15, 39, 36, 45, 54, 61) at a holding point (8) for holding the structural component (7, 16, 30) in an injection-molding die or a casting mold.

30. The method according to claim 29, further comprising holding the structural component (7, 16, 30) in the injection-molding die or casting mold by arranging the holding point covering (12, 15, 39, 36, 45, 54, 61) between the structural component (7, 16, 30) and a positioning element (24, 34, 40, 50, 60, 70, 71) of the injection-molding die or the casting mold.

31. The method according to claim 29, wherein the holding point covering (12, 15, 39, 36, 45, 54, 61) is partially overmolded and/or embedded by casting in the material of the casing (2, 18, 32, 38, 56, 57, 79), whereby the holding point covering (12, 15, 39, 36, 45, 54, 61) is firmly connected to the casing (2, 18, 32, 38, 56, 57, 79) and/or to the structural component (7, 16, 30).
